(19) United States
(12) Patent Application Publication
(10) Pub. No.: US 2026/0158449 A1
(43) Pub. Date: Jun. 11, 2026

(54) PERCOLATION-ASSISTED COATING OF METAL-ORGANIC FRAMEWORKS (MOFs) ON POROUS SUBSTRATES

(71) Applicant: The Board of Trustees of the University of Illinois, Urbana, IL (US)

(72) Inventor: Meenesh R. Singh, Naperville, IL (US)

(21) Appl. No.: 19/129,162

(22) PCT Filed: Nov. 15, 2023
(86) PCT No.: PCT/US2023/079748

§ 371 Date: May 12, 2025

Related U.S. Application Data
(60) Provisional application No. 63/425,720, filed on Nov. 16, 2022.

(51) Int. Cl. B01D 67/00; B01D 53/22; B01D 71/02; B01J 20/22; B01J 20/28; B01J 20/30; B01J 20/32

(52) U.S. Cl. CPC B01D 67/0079; B01D 53/228; B01D 71/028; B01J 20/226; B01J 20/28035; B01J 20/3071; B01J 20/3212; B01J 20/3265; B01J 20/3297

(57) ABSTRACT

A percolation-assisted coating (PAC) process that combines top-down and bottom-up approaches in a continuous-flow microfluidic device to deposit metal organic frameworks (MOFs) on a porous substrate. Methods of coating a porous substrate with MOF, comprising flowing a MOF precursor composition comprising MOF secondary building units (SBUs) and combinations of SBUs suspended in a solvent through a porous substrate having a first face and a second face, thereby depositing MOF SBUs and combinations of SBUs on the first face of the porous substrate, wherein each of the MOF SBUs comprise a metal ion coordinated to an organic linker, and wherein during flowing the MOF precursor composition through the porous substrate, MOF SBUs and combinations of SBUs self-assemble into MOF crystals to provide a porous substrate coated with a thin film of MOF crystals on the first face of the porous substrate.

### CROSS REFERENCE TO RELATED APPLICATIONS

This application claims the benefit under 35 U.S.C. § 119 (e) of U.S. Provisional Patent Application No. 63/425,720, filed Nov. 16, 2022, the entire disclosure of which is incorporated herein by reference.

### FIELD

The disclosure relates generally to methods of preparing thin films of metal-organic frameworks on porous substrates. More specifically, the disclosure provides percolation-assisted coating of metal-organic frameworks (MOFs) on porous substrates, porous substrates coated with metal-organic frameworks, and methods of using same.

### BACKGROUND

Metal-organic frameworks (MOFs) are a class of hybrid, porous crystalline materials that have gained significant attention in the previous two decades. These complex networks are formed by self-assembly and oriented attachment of metallic nodes/ions (mainly transition metals) connected by an organic linker.

These periodic networks exhibit large specific surface area, ordered pore diameters, and flexibility for functional group modifications as needed, thus making them a frontrunner in a wide range of applications. Numerous studies have demonstrated MOFs, like UIO-66, HKUST-1, MIL-53, MOF-5, etc., as excellent candidates in catalysis, gas adsorption and separation, and water purification. The majority of these current applications use these materials as a film/membrane (either free-standing or deposited on a substrate); thus, it is essential to fabricate uniform and conformally coated MOF films with optimal thickness and mechanical strength.

Pure or composite MOF films are deposited on a wide range of substrates (solid and porous) by various solvothermal, electrochemical, and coating techniques. Solvothermally, layer-by-layer (LbL) fabrication of MOFs is one of the primal techniques proposed by Fischer and co. to deposit thin films of MOF-5 on gold substrates utilizing a self-assembled monolayer (SAM). Similar approaches have been implemented in fabricating HKUST-1 films by Farha and coworkers, while also displaying the effect of solvents on the qualitative aspects of the films. Although several studies claim that this approach yields desired thickness and loading, the approach requires precise control of heterogeneous nucleation to ensure uniform deposition. As a result, the LbL protocol is very time and labor-intensive.

As an alternative to a bottom-up approach like LbL, where the crystallization is carried out directly on the substrate, researchers have also implemented top-down approaches, in which the crystals are synthesized in batch and then suspended in a liquid matrix to coat them on a substrate. Coating can be carried out in a variety of approaches like spin coating, dip coating, titration coating, etc. While coating ensures a uniform and conformal deposition, controlling the quantitative aspects of the film such as thickness, grain size distribution, and uniformity, limited scalability of the process and lower adhesion of the deposited material on the substrate have been the primary concerns of this approach.

In conjunction with these approaches, continuous processing techniques have also been employed to overcome some of the diffusion limitations and turbulent environments. These approaches have allowed significant control over the final attributes, like film thickness and grain size distribution of the deposited crystallites. The early-stage continuous microfluidic synthesis of thin films was conducted using hollow fibers to fabricate thin films of ZIF-8. Along with this approach, nanoconfined channels have been used to fabricate high aspect ratio deposition on the substrates. Supersaturation-induced film deposition is one of the most popular continuous microfluidic techniques, where the reaction between the precursors is induced by vaporizing the solvent via blade shearing.

While these continuous techniques have proven to be effective in improving the final adhesion and minimizing the inter-grain spacing of the films, they have mostly been implemented on solid substrates. In the case of gas separations, pure MOF film depositions are required on a porous membrane while ensuring strong adhesion, minimal grain boundary defects, low inter-grain spacing, and narrow size distribution of the deposited crystallites. Obtaining pure MOF membranes on porous substrates while ensuring these qualities has been challenging in the top-down and bottom-up approaches mentioned previously due to cracking and weak bonding with the substrates resulting in lower mechanical integrity and many stability concerns. These properties are essential to address for gas separation applications, as they determine the selectivity of the transport pathways for gas molecules in binary or ternary mixtures.

Thus, there is a need for improvement in the coating processes for the fabrication of robust, uniform, and scalable films.

### SUMMARY

The disclosure provides a method of coating a porous substrate with a metal-organic framework (MOF) comprising flowing a MOF precursor composition comprising MOF secondary building units (SBUs) and combinations of SBUs suspended in a solvent through a porous substrate having a first face and a second face, thereby depositing MOF precursor units on the first face of the porous substrate, wherein each of the MOF SBUs comprise a metal ion coordinated to an organic linker, and wherein during flowing the MOF precursor composition through the porous substrate, MOF SBUs and combinations of SBUs self-assemble into MOF crystals to provide a porous substrate coated with a thin film of MOF crystals on the first face of the porous substrate.

The disclosure further provides a separation membrane for separating a binary gas mixture comprising porous substrate coated with a metal-organic framework of the disclosure.

The disclosure further provides a method of separating a binary gas mixture comprising flowing a binary gas mixture through a separation membrane of the disclosure.

The disclosure further provides a material substrate, device, or system comprising the separation membrane of the disclosure to facilitate the separation of binary gas mixtures.

Further aspects and advantages will be apparent to those of ordinary skill in the art from a review of the following detailed description. While the methods, porous substrates coated with a metal-organic framework, separation membranes, and uses thereof disclosed herein are susceptible of embodiments in various forms, the description hereafter includes specific embodiments with the understanding that the disclosure is illustrative and is not intended to limit the invention to the specific embodiments described herein.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings.

FIG. 1 is an in-situ batch FTIR experimental setup for preparing a MOF thin film on a porous substrate using methods of the disclosure.

FIG. 2 is an FTIR Calibration plot for known HKUST-1 concentrations in DMF.

FIG. 3 is an experimental set up for thin film MOF synthesis according to methods of the disclosure.

FIG. 4 is a schematic of the reactor (top), mesh (middle), and vacuum chamber (bottom) layers of one embodiment of a microfluidic device for carrying out the percolation assisted coating methods of the disclosure.

FIG. 5 demonstrates the effect of pH at high temperature of the reactant solution on ZnSe crystal.

FIG. 6 is a BET adsorption-desorption N₂ isotherm.

FIG. 7 is an example of an SEM of a MOF-505 film of the disclosure deposited on a nylon substrate using the percolation-assisted coating method of the disclosure.

FIG. 8 is a schematic for a gas separation application of the disclosure.

FIG. 9A is a schematic of a 4 well device for fabricating multiple films of the disclosure having MOF coatings according to methods of the disclosure.

FIG. 9B is a schematic of a multiple well device with flow distributor for fabricating multiple films of the disclosure having MOF coatings according to methods of the disclosure.

FIG. 10 is a schematic of a microfluidic setup for the percolation-assisted coating process of the disclosure showing a reaction chamber, a membrane filter porous substrate between the reaction chamber and a supporting mesh, and a vacuum chamber. Also shown is an SEM image of an MOF coating of the disclosure deposited on the porous substrate and a zoomed-in view of single crystal HKUST-1.

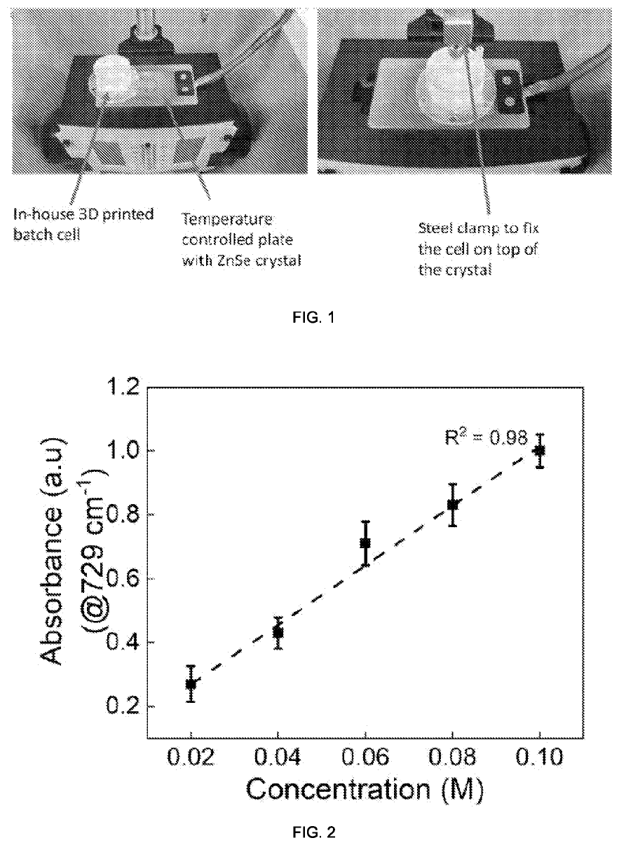

FIG. 1 is a schematic of the fabrication of HKUST-1 films of the disclosure in a reactor-separator assembly using in-situ batch experiments combined with modeling and simulations in SOMSOL to design and model a lab-scale tubular flow reactor.

FIG. 12A demonstrates an increase in absorbance as a function of time for HKUST-1 peaks between 1800 cm-1 to 650 cm 1 in the mid-IR region.

FIG. 12B is a magnified view of the 729 cm⁻¹ signature peak of Cu—O bond in HKUST-1 from FIG. 12A.

FIG. 12C is a plot of fractional crystalline yield vs. time obtained from batch in-situ FTIR experiments at varying temperatures.

FIG. 12C is an Arrhenius plot obtained from rate constants at corresponding temperatures from batch experiments in FIG. 12C. The obtained plot was extrapolated to predict the rate constants at higher temperatures further utilized in continuous tubular reactor design.

FIG. 13A shows the volumetric flowrate (mL/min) profile for COMSOL Multiphysics simulations to obtain different profiles across the length of the reaction channel at a flowrate of 1 mL/min (0.5 mL/min each precursor) and 90° C. inlet temperature of each precursor. The length of the channel is set to 82 mm.

FIG. 13B is a temperature profile (C) for COMSOL Multiphysics simulations to obtain different profiles across the length of the reaction channel at a flowrate of 1 mL/min (0.5 mL/min each precursor) and 90° C. inlet temperature of each precursor. The length of the channel is set to 82 mm.

FIG. 13C shows the HKUST-1 crystalline yield profile across the length of the channel for COMSOL Multiphysics simulations to obtain different profiles across the length of the reaction channel at a flowrate of 1 mL/min (0.5 mL/min each precursor) and 90° C. inlet temperature of each precursor. The length of the channel is set to 82 mm.

FIG. 13D is the HKUST-1 crystalline fraction predicted at different temperatures and residence times from COMSOL simulations.

FIG. 13E is the predicted mass loading and thickness of HKUST-1 films as a function of residence times with reaction temperature of 90° C. from COMSOL simulations.

FIG. 14A is a powder-XRD spectra of HKUST-1 film of the disclosure on a nylon substrate.

FIG. 14B shows the pore size distribution of the HKUST-1 powder deposition obtained form BET measurements-N2 adsorption isotherm

FIG. 14C is the theoretically predicted and experimentally obtained mass loadings of HKUST-1 films of the disclosure vs. processing times at t=90° C. and fixed residence time of 24 seconds (fixed operating flowrate=1 mL/min).

FIG. 14D is a cross-sectional view of the HKUST-1 film of the disclosure under an optical microscope, obtained after 20 minutes of processing at t=90° C. and fixed residence time of 24 seconds (fixed operating flow rate=1 mL/min).

FIG. 14E is a cross-sectional view of the same HKUST-1 film of FIG. 14D obtained from SEM imaging.

FIG. 14F is the theoretically predicted and experimentally obtained thicknesses of HKUST-1 films vs. processing times at T=90° C. and fixed residence time of 24 seconds (fixed operating flowrate=1 mL/min).

FIG. 15A is a SEM image of a vacuum-dried MOF film of the disclosure before sonication.

FIG. 15B is a SEM image of a vacuum-dried MOF film of the disclosure as in FIG. 15A, after 30 minutes sonication. The film was fabricated at 1 mL/min flowrate and 90° C.

FIG. 15C is a SEM image of a vacuum-dried MOF film of the disclosure as in FIG. 15A, after 60 minutes sonication. The film was fabricated at 1 mL/min flowrate and 90° C.

FIG. 15D is a SEM image of a vacuum-dried MOF film of the disclosure as in FIG. 15A, after 120 minutes sonication. The film was fabricated at 1 mL/min flowrate and 90° C.

FIG. 15E is chart of percentage of porous substrate covered with the MOF film vs. sonication time for the films of FIG. 15A to 15D.

FIG. 16A is a schematic of CH₄/H₂ gas separation using HKUST-1 membranes of the disclosure. The feed stream flowrate is 200 SCCM (100 SCCM CH₄ and 100 SCCM H₂), and Argon (Ar) is used as carrier gas on the permeate side. Ar is passed at 200 SCCM flowrate on the permeate side that carries certain amounts of CH₄ and H₂ through the membrane sent to Gas chromatography (GC) to determine the concentration of each gas.

FIG. 16B is a 3D design isometric view of a device used for gas separation experiments. The HKUST-1 deposited on nylon using methods of the disclosure is sandwiched between the two 3D printed feed and permeate chambers.

FIG. 16C is a plot of the concentration of H₂ and CH₄ gasses on the permeate side from the GC vs. time (for a single run) for blank nylon and HKUST-1 thin films of the disclosure having different thicknesses.

FIG. 16D is a plot of the separation factor for blank nylon and HKUST-1 thin films of the disclosure having different thicknesses, as a function of time.

### DETAILED DESCRIPTION

The disclosure provides a new, continuous, in-situ approach, which involves a coupled seeding (bottom-up approach) and percolation (top-down approach) deposition method, demonstrated herein on HKUST-1. This technique, coupled with solvent choices and post-processing procedures, ensures a well-patched, continuous network with conformal material deposition and minimal inter-grain spacing, and yields controlled film thicknesses and mass loading. HKUST-1 has proven to be an excellent exemplary candidate for the separation of many binary gas mixtures, for example CO₂/N₂, CO₂/CH₄, CH₄/H₂, etc. For example, the effectiveness of the fabricated HKUST-1 films has been demonstrated herein in the separation of CH₄/H₂ mixture.

Thus, a new percolation-assisted coating (PAC) process that combines top-down and bottom-up approaches in a continuous-flow microfluidic device to deposit suitable metal organic frameworks (MOFs), such as HKUST-1, and other nanocrystalline materials on a porous substrate is set forth. As a result, new materials, devices, and systems can be formed thereby to facilitate separation of binary gas mixtures and the like as a result of both the multi-chamber design of the microfluidic device for high-throughput screening of thin-film growth and the PAC process set forth herein.

Nanocrystalline compounds are next generation materials that will prove effective in solving the ongoing climate crisis. In the field of materials science and engineering, porous materials like metal-organic frameworks (MOFs) have been extensively used for gas storage, catalysis in form of thin films. However, these films are usually deposited on solid substrates due to decent adhesion and physical-chemical stability.

In accordance with the principles herein, deposition of MOFs and other nanocrystalline materials on porous substrates is successfully carried out, as discussed in the exemplary embodiments. Currently, there are no other known technology that can coat MOFs on a porous substrate. For effective membrane separation applications, these materials need to be deposited on a porous membrane like PTFE, Nylon, PVDF etc.

In accordance with the principles herein, percolation-assisted coating, or PAC, technology addresses the adhesion and stability problems of these compounds on the porous substrates ensuring a sustainable membrane fabrication process. The process can include combined top-down and bottom-up approaches in a continuous-flow microfluidic device to deposit MOFs on a porous substrate.

Devices/substrates constructed in accordance with the principles herein can be fabricated using a unique 3D printed tubular flow reactor-separator assembly, a well-controlled continuous approach to fabricating films on suitable MOF substrates, such as HKUST-1, with a wide range of thicknesses (for example 20-200 μm) and mass loading (for example 5-50 mg/cm²) is presented. HKUST-1 can continuously form in a tubular chamber, opening into a square chamber where the HKUST-1 building blocks (crystallites comprising secondary building units (SBUs) and combinations of SBUs) are deposited on a porous substrate. Once the deposition is complete, vacuum can be applied to eliminate the small amounts of reactant effluent (MOF precursor composition) trapped in the film/substrate. FIG. 11 shows the overall schematic of the exemplary workflow.

Batch in-situ Fourier Transformed Infrared Spectroscopy (FTIR) experiments can be first performed to study the kinetics of HKUST-1 formation for a range of temperatures. The reactive transport in microfluidic channels can then be simulated using the measured rate constants in COMSOL Multiphysics can be used to obtain MOF yield and mixing profiles. Scanning Electron Microscopy (SEM) and optical microscopy can be used to measure the thicknesses of MOF films. Brunauer-Emmett-Teller (BET) measurements of exfoliated films can confirm the characteristic porosity of HKUST-1, for example. Postprocessing strategies can be applied to quantify the mechanical strength and adhesion of the films. Finally, the performance of these films for CH₄/H₂ separation can be demonstrated, where HKUST-1 showed higher selectivity for CH₄, similar to what has been observed in previous studies.

The disclosure provides methods of coating a porous substrate with a metal-organic framework (MOF), comprising flowing a MOF precursor composition comprising MOF secondary building units (SBUs) and combinations of SBUs suspended in a solvent through a porous substrate having a first face and a second face, thereby depositing MOF precursor units on the first face of the porous substrate, wherein each of the MOF SBUs comprise a metal ion coordinated to an organic linker, and wherein during flowing the MOF precursor composition through the porous substrate, MOF SBUs and combinations of SBUs self-assemble into MOF crystals to provide a porous substrate coated with a thin film of MOF crystals on the first face of the porous substrate.

MOF crystals are organized networks that are formed by self-assembly and oriented attachment of metallic nodes/ions (mainly transition metals) connected by an organic linker. The basic building block of the MOF crystal is referred to herein as a MOF secondary building unit (SBU). The SBU comprises a MOF precursor metal coordinated to an MOF precursor organic linker. In the process of forming MOF crystals, the SBUs combine to form structures intermediate to the SBU and the crystal. The intermediate structures are referred to herein as “combinations of SBUs” and can include two or more SBUs. The SBUs and combinations of SBUs can assemble in situ to form a lattice and, ultimately, the MOF crystal.

The methods of the disclosure can further comprise admixing a composition comprising MOF precursor metals (also referred to herein as the MOF precursor metal composition) and a solvent and a composition comprising MOF precursor organic linkers (also referred to herein as the MOF precursor organic linker composition) and a solvent to form the MOF precursor composition comprising SBUs and the combinations of SBUs.

As the MOF precursor composition flows through the porous substrate, the SBUs and combinations of SBUs are deposited on a first face of the porous substrate. During flowing, additional SUBs and combinations of SBUs come into contact with the SBUs and combinations of SBUs deposited on the first face of the porous substrate and self-assemble into larger units and ultimately, MOF crystals.

In general, the porous substrate is not particularly limiting. The pores of the porous substrate should be large enough to allow the solvent to pass through the substrate, but small enough to retain the SBUs and/or combinations of SBUs. The porous substrate can be any porous material that can sustain the MOF synthesis conditions described herein. The porous substrate can comprise a porous polytetrafluoroethylene (PTFE) sheet, a porous polyvinylidene fluoride (PVDF) sheet, or a porous nylon sheet. The porous substrate can comprise a porous nylon sheet.

In general, the MOF precursor metal can be any metal precursor known for preparing MOFs. The MOF precursor metal can include metal-oxo clusters, metal salts, and combinations thereof. Suitable metal-oxo clusters include, but are not limited to, clusters of Zr, Ti, Hf, or other high valence metals. The metal-oxo clusters can include clusters of Zr, clusters of Ti, clusters of Hf, or combinations thereof. Suitable metal salts include, but are not limited to, Cu, Al, Ni, Fe, and the like. The metal salts can include salts of Cu, salts of Al, salts of Ni, salts of Fe, or combinations thereof.

In general, the MOF precursor organic linker can be any organic linker known for preparing MOFs. The MOF organic linker can be a ditopic, tritopic, or tetratopic linker, or a combination thereof. Suitable ditopic linkers include, but are not limited to, benzene dicarboxylic acid. Suitable tritopic linkers include, but are not limited to, trimesic acid. Suitable tetratopic linkers include, but are not limited to, 3,3′,5,5′-biphenyltetracarboxylic acid and 1,3,6,8-tetrakis(p-benzoic acid) pyrene. 3,3′,5,5′-biphenyltetracarboxylic acid can attach in a 12 connected manner to, e.g., a Zr-oxo node. 1,3,6,8-tetrakis(p-benzoic acid) pyrene can attach in an 8 connected matter to, e.g., a Zr-oxo node.

The MOF precursor composition, MOF precursor metal composition, and MOF precursor organic linker composition can include a solvent. As used herein, the solvent need not dissolve the MOF precursor metal, MOF precursor organic linker, SBUs, or combination of SBUs, but acts as a carrier for the MOF precursor metal, MOF precursor organic linker, SBUs, and combination of SBUs. The solvent can be selected from an alcohol, a non-aqueous solvent, water, and a combination thereof. Suitable alcohols include, but are not limited to, ethanol. Suitable non-aqueous solvents include, but are not limited to, dimethyl formamide, dimethyl sulfoxide, or a combination thereof.

During the flowing of the MOF precursor composition, the MOF precursor composition travels a path from an injection area wherein the MOF precursor metal composition is admixed with the MOF precursor organic linker composition to form the MOF precursor composition to a chamber wherein the porous substrate is secured. Along the path of travel, the MOF precursor metal combines with the MOF precursor organic linker to form SBUs and the SBUs combine to form combinations of SBUs. Ultimately, the SBUs and combinations of SBUs enter the chamber at the end of the path of travel and contact the porous substrate and further combine/self-assemble to form the MOF crystals.

The flow rate of the MOF precursor composition along the path and through the porous substrate and the temperature of the MOF precursor composition during flowing can be used to control the growth of the MOF crystals, as well as the yield of MOF crystals, thickness of MOF coating on the porous substrate, and uniformity of MOF coating on the porous substrate.

The flowing of the MOF precursor composition through the porous substrate can generally be done at any rate suitable to allow the SBUs and combinations of SBUs to interact with and adhere to the porous substrate. Without intending to be bound by theory, it is believed that as the flow rate of the MOF precursor composition increases, more MOF precursor composition moves through the porous substrate, minimizing the heterogeneous growth on the substrate if desired. However, in the best interest of obtaining well-adhered and contiguous films, heterogeneous growth, to some extent, is desirable. Compared to films fabricated at high flow rates (low residence times of the MOF precursor composition in the chamber prior to passing through the porous substrate), films fabricated at low flow rates (high residence times of the MOF precursor composition in the chamber prior to passing through the porous substrate), significant differences in the adherence to these substrates were observed. To provide a uniform MOF thin film on the first face of the porous substrate, the flow MOF precursor composition can have a uniform flow distribution along the path and into the chamber.

The flowing of the MOF precursor composition can be performed for a time and at a rate sufficient to provide a predetermined thickness of the thin film of MOF coated on the porous substrate. Suitable flow rates and times to arrive at a desired film thickness can be determined by simulation, as described in detail in the Examples.

In general, the flowing of the MOF precursor composition can be done at any temperature sufficient to promote the bulk synthesis of the MOF crystals. As described in detail in the Examples herein, a bulk synthesis of MOF crystals can be prepared to determine the rate-kinetics, activation energy, and ultimately temperature required to facilitate MOF crystal formation from the MOF precursor metal and MOF precursor organic linker. Such bulk MOF syntheses are routinely done in the field of MOF preparation.

The temperature of the MOF precursor composition during flowing can be in a range of about 50° C. to about 110° C., about 60° C. to about 100° C., about 70° C. to about 90° C., or about 80° C. The MOF precursor metal composition and the MOF precursor organic linker composition can be pre-heated before admixing to a temperature in a range of about 50° C. to about 110° C., about 60° C. to about 100° C., about 70° C. to about 90° C., or about 80° C.

As temperature of the MOF precursor composition fluctuates during flowing, the uniformity of the resulting MOF thin film also fluctuates. During flowing, the temperature of the MOF precursor composition can be controlled to have a variation of no greater than 5° C., for example, the variation in temperature can be between 0° C. and 5° C.

The path length for flowing the MOF precursor composition can be selected such that combinations of SBUs form during flowing, but large MOF crystals do not form along the path. As used herein, a large crystal refers to a crystal size greater than about 10 nm. The path length can be sufficient to prevent the MOF SBUs and combinations of SBUs from forming large crystals prior to depositing on the porous substrate. Without intending to be bound by theory, it is believed that SBUs and small combinations of SBUs can interact with the first face of the porous substrate to provide nucleation sites for self-assembly of large MOF crystals. Further, without intending to be bound by theory, it is believed that as the SUBs and combinations of SBUs contact the nucleation sites, an MOF network grows on the first face of the porous substrate, securing the growing MOF network and crystals to the porous substrate and forming a well adhered thin layer of MOF crystals. In contrast, without intending to be bound by theory, it is believed that any large crystals that may form in the MOF precursor composition along the path and prior to depositing on the first face of the porous substrate do not interact with the porous substrate in the same way as the SBUs and combinations of SBUs, do not adhere to the porous substrate as strongly as the SBUs and combinations of SBUs, and, therefore, as the amount of large MOF crystals present in the MOF precursor compositions increases, the adherence and stability of the resulting MOF thin film decreases.

The methods of the disclosure can further comprise stopping the flow of the MOF precursor composition. The flow of the MOF precursor composition can be stopped at any time after a desired time has passed, for example, after about 2 minutes, after about 5 minutes, after about 7 minutes, after about 10 minutes, after about 12 minutes, after about 15 minutes, after about 17 minutes, after about 20 minutes, after about 25 minutes, or after about 30 minutes. In general, as the time of flowing increases, the thickness of the resulting MOF coating increases and as the time of flowing decreases, the thickness of the resulting MOF coating decreases. Thus, the flow of the MOF precursor composition can be stopped at any time after a desired MOF coating thickness has been obtained. The flow of the MOF precursor composition can also be stopped when the resistance of the MOF precursor composition to flowing through the porous membrane is high enough that little to no solvent passes through the porous membrane.

The thin films of MOFs coated on the porous substrate can comprise a well-patched, contiguous network of MOF crystals. Well-patched refers to coating that prevents any convective leak but allows gas diffusion for separation applications. The thin films of MOFs coated on the porous substrate can be patched by continuing the flow of MOF precursor units until little to no MOF precursor composition or solvent from the MOF precursor composition can pass through the porous substrate and the pressure of the continuous flow of the MOF precursor composition forces additional SBUs and combinations of SBUs to self-assemble on the growing MOF network and cover any gaps in network coverage. Alternatively, or in addition, once the flow of the MOF precursor composition is stopped, a vacuum can be applied at the second face of the porous substrate, drawing out any residual solvent and forcing remaining SBUs and combinations of SBUs in contact with the growing MOF network thereby covering any gaps in network coverage. Thus, the methods of the disclosure can further include applying a vacuum to the second face of the porous substrate, thereby patching the thin film to forma contiguous network of the MOF crystals. The vacuum can be applied until no liquid is withdrawn through the porous membrane.

The MOF coated porous substrates can be washed to remove any trapped solvent and/or residual unreacted MOF precursor metals and/or MOF precursor linkers. Washing the porous substrates coated with the thin film of MOF crystals can include soaking the porous substrate coated with the thin film of MOF crystals in a solvent. Suitable solvents include alcohols, including but not limited to, ethanol. The MOF coated porous substrates can be washed at least two, at least three, or more than three times. The washing can be performed prior to removing the MOF coated porous substrate from the device used to prepare the MOF thin film coating.

After washing, the MOF coated porous substrates can be dried using any suitable method. The MOF coated porous substrate can be at least partially dried prior to removing the MOF coated porous substrate from the device used to prepare the coating. Without intending to be bound by theory, it is believed that partially drying the MOF coated porous substrate in the device used to prepare the coating allows the porous substrate to dry to prevent the substrate from sticking to the device. Once removed from the device, the MOF coated porous substrate can be further dried en vacuo alone or in combination with conventional oven.

The disclosure further provides a separation membrane for separating a binary gas mixture comprising an MOF coated porous substrate. The MOF coated porous substrate of the separation membrane can be well patched and contiguous. The MOF can comprise any MOF suitable for selectively adsorbing one gas of the binary mixture. The MOF can comprise HKUST-1, MOF-5, MOF-505, or a combination thereof. The MOF coating of the separation membrane can comprise nanocrystalline materials other than HKUST-1, MOF-5, or MOF-505. The separation membrane can be expandible. The disclosure further provides a method of separating a binary gas mixture comprising flowing a binary gas mixture through a separation membrane of the disclosure. The disclosure further provides a material substrate, device, or system comprising the separation membrane of the disclosure to facilitate the separation of a binary gas.

The binary gas mixture can be any binary gas mixture that includes one gas that is selectively adsorbed by the MOF coated porous substrate and a second gas that is not adsorbed by the MOF coated porous substrate or a second gas for which the MOF coated porous substrate has a substantially lower selectivity. Suitable binary gas mixtures include, but are not limited to, CO₂/N₂, CO₂/CH₄, CH₄/H₂, or O₂/N₂. The binary gas mixtures can be for air separation or industrial gas separation.

The following examples are provided for illustration and are not intended to limit the scope of the invention.

### Examples

### Materials

Copper nitrate trihydrate (Cu(NO₃)₂. 3H₂O), Trimesic acid (BTC), Dimethyl Formamide (DMF) and Ethanol were purchased from Sigma Aldrich and were used without further purification. 0.4 M Copper nitrate trihydrate (Cu(NO₃)₂. 3H₂O) and 0.22 M Trimesic acid (BTC) were individually dissolved in Dimethylformamide (DMF) and used for all batch in-situ FTIR, and HKUST-1 film deposition exemplary processes with final concentrations of approximately 0.4 M and 0.22 M respectively, in the reactant mixture. Ethanol was used for thorough washing of the HKUST-1 films post deposition. Details are provided in the additional description below.

### In-Situ Kinetic Studies Using FTIR

The batch kinetics of HKUST-1 formation was studied using in-situ FTIR in ATR mode. As shown in FIG. 1, an in-house 3D printed cell was mounted on a temperature controlled ZnSe ATR crystal plate and a total of 1 mL reactant mixture (copper nitrate trihydrate and trimesic acid) was loaded into the cell. The experiments were performed at different temperatures to obtain the Arrhenius plot (FIG. 12C) that further yields the activation energy value required for COMSOL simulations. The calibration plot of known HKUST-1 concentrations in DMF is shown in FIG. 12.

In-situ FTIR experiments for batch syntheses were initially performed to obtain the rate kinetics of HKUST-1 formation. The experimental setup and strategy were similar to the in-situ FTIR studies performed in previously published work, where rate kinetics of UIO-66 were computed and found to be in agreement with the Wide-Angle X-ray Scattering (WAXS) studies.

FIG. 12A shows the spectral signature of the exemplary synthesized HKUST-1 in real-time, where the C═O peak at 1633 cm⁻¹, C—O at 1370 cm⁻¹, and the C—H out of plane bending at 729 cm⁻¹ are HKUST-1's molecular signatures. Absorbance at the unique peak at 729 cm⁻¹ was chosen to be correlated with HKUST-1 formation to determine the yield in real time due to its reliable and reproducible intensities at specific product concentrations. Calibration of the signal at 729 cm⁻¹ was performed with known concentrations of HKUST-1 (FIG. 2).

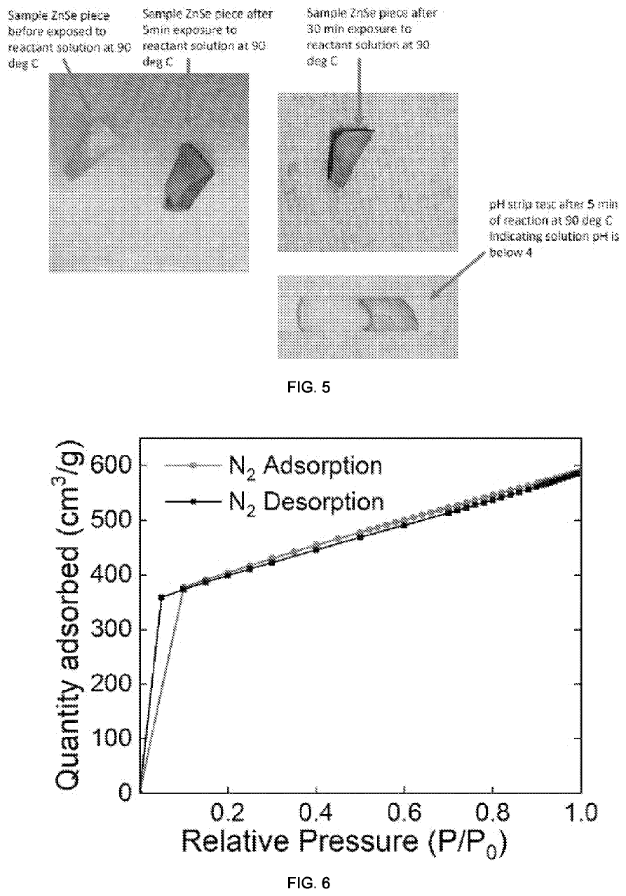

FIG. 12B shows the increase in intensity at 729 cm⁻¹ as a function of time during the reaction between the precursors (T=60° C.). Using this calibration model, the crystalline yield was calculated at different time points during the synthesis, which was, in turn, studied at multiple temperatures, as shown in FIG. 12C. The rate constants for each temperature were determined using the differential rate expression, compiled as the Arrhenius plot in FIG. 12D. From this information, the overall activation energy was calculated to be 64.83 KJ/mol, which is in agreement with the previously published in-situ WAXS studies (˜64-72 KJ/mol). Due to experimental limitations involving the ATR ZnSe crystal, elucidated in the additional description and FIG. 5, studies in the batch mode were performed only up to 600° C. The activation energy obtained from the process was utilized to model reaction profiles and the product distribution in the reaction chamber (shown in FIG. 13) using COMSOL.

### COMSOL Simulations

To design the continuous microfluidic reactor, a preliminary 3D model of the reactor was charted in Solidworks. The 2D geometry of the reaction chamber was imported into COMSOL to setup Multiphysics simulations to gain further insights into the yields, the velocity profiles and temperature drops across the length of the reactor, and concentration profiles of the reacting species. The effect of temperature and flowrates (or residence time) on the final crystalline yield of HKUST-1 and uniformity of the deposition in the square chamber were studied. A broad parameter range for flowrates (0.5 to 3 mL/min) and temperatures (60 to 100° C.) was used as the simulation space to understand the final product profiles, which facilitated the determination of an exemplary design operation space for film deposition. To account for the reaction between the MOF precursor metal ions (copper nitrate trihydrate) and MOF precursor organic linkers (trimesic acid), the activation energy and the pre-exponential factor obtained from the batch experiments were used in the Arrhenius equation to compute the rate constants. Navier Stokes equation was solved simultaneously with the continuity and energy balance equations to obtain the reaction and the temperature profiles. A typical physics-controlled mesh was utilized with the normal element size to perform these simulations. Further specific details of the computations are included in the additional description below.

The flow velocity profiles were first studied, as shown in FIG. 13A, which helps visualize patterns as the inlet of each precursor is set to 0.5 mL/min leading to an average flowrate of 1 mL/min. The gradient across the cross-section of the channel is due to the parabolic average velocity profile typically observed in laminar flows. Similar profiles were obtained across the range of all flowrates tested. To ensure that the reaction proceeds with significant yield, it was essential to understand the temperature drops across the length of the reactor. This was simulated by tweaking the channel length between 60 to 100 mm, where negligible temperature drops were observed across the channel length (FIG. 13B). This result assisted in eliminating irregular temperatures as a variable and reducing the model to account only for the most important variable, the residence time, to calculate yield.

To study the HKUST-1 formation profile, the activation energy from the batch process was utilized by the Arrhenius expression in the Chemistry module to calculate rate constants at desired temperatures. These constants, coupled with temperature and flowrates used in the simulation, provided the crystalline yield profiles, as shown in FIG. 13C. For the tested variable ranges, a yield between 5 to 10% was obtained at the exit of the channel, which opens to the square chamber.

This result is crucial because (1) it informed the mechanical design of the reactor, i.e., the length and diameter of the tubular channel (path); (2) it provided the uniform dispersion profile of the reaction effluent after it exited the tubular channel; and lastly (3) the effects of residence time in controlling the heterogeneous nucleation and growth on the porous substrate to some extent in the square chamber were assessed, which is discussed further below.

The predicted final crystalline yields were obtained at various residence times for temperatures 70, 80, and 90° C., as shown in FIG. 13D. Significant crystalline yield is obtained at higher temperatures and longer residence times, due to which the temperature of the precursors was maintained at 90° C. during the process. As a best condition case, the mass loading and thickness of deposition across different residence times at this temperature were evaluated and graphed in FIG. 13E. The final crystalline yield in the square chamber of the device was averaged in FIG. 13D and FIG. 13E due to the presence of a slight gradient, as seen in FIG. 13C. These findings gave us strong insights into efficiently controlling the loading and thickness of the films while conducting the experiments.

Furthermore, based on the mechanical design parameters obtained from COMSOL simulations, a 3D model of the exemplary fabrication device was formed as shown in FIG. 1.

### Microfluidic Setup

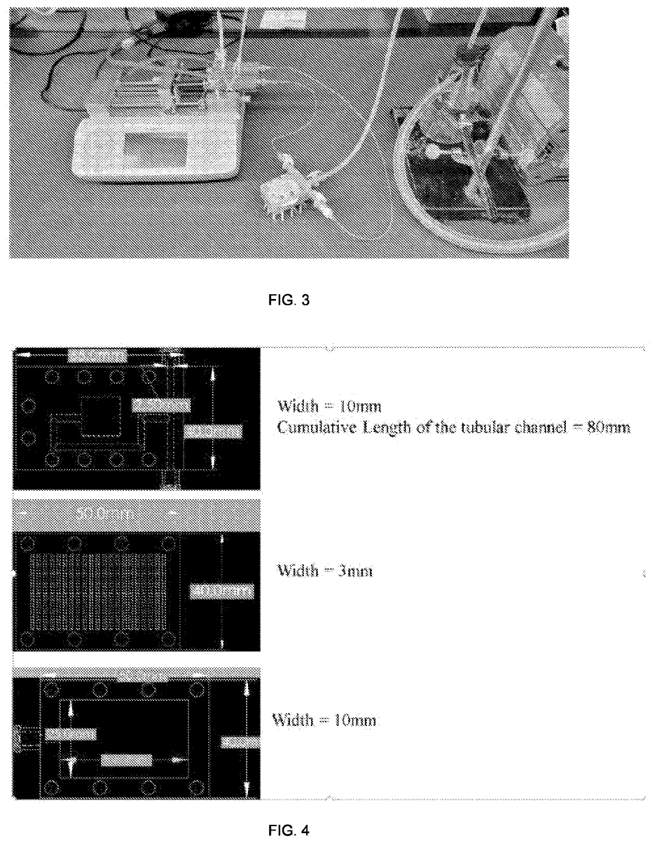

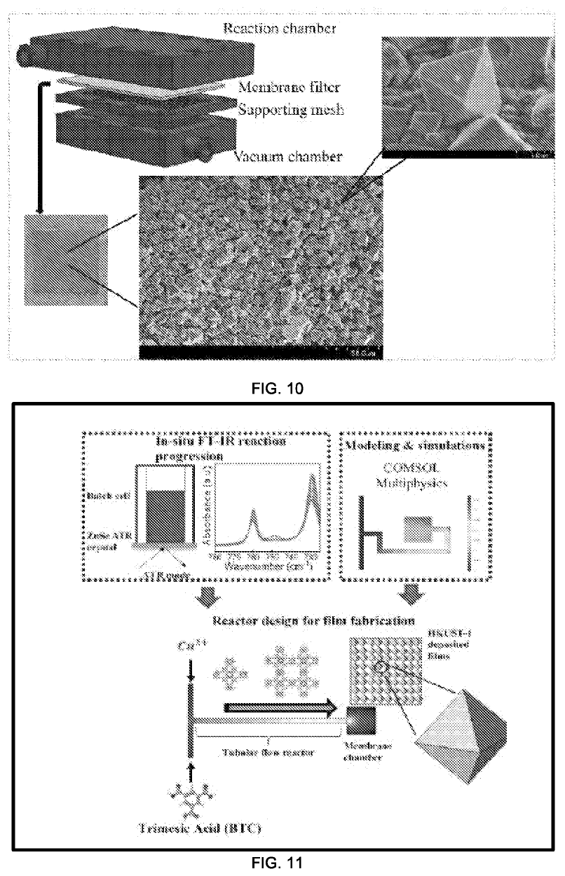

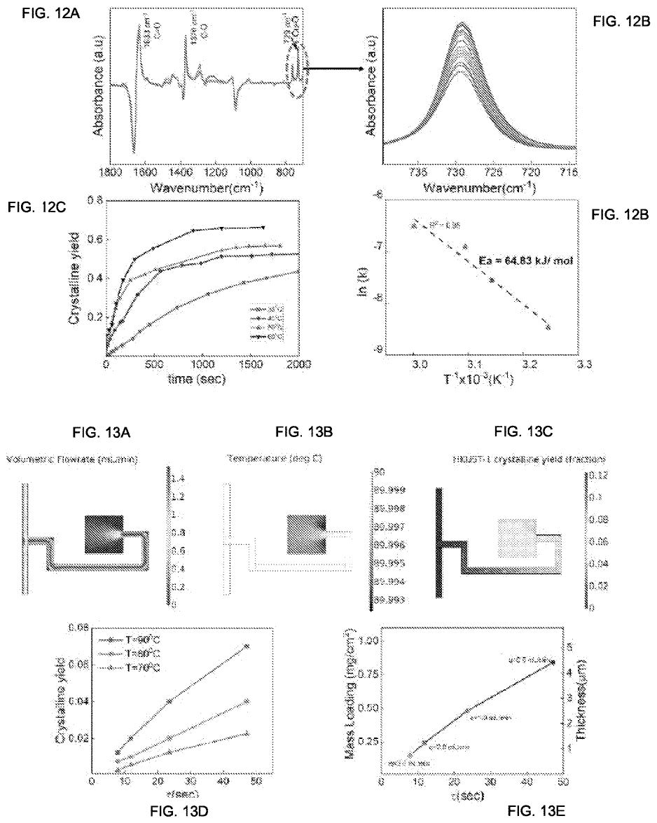

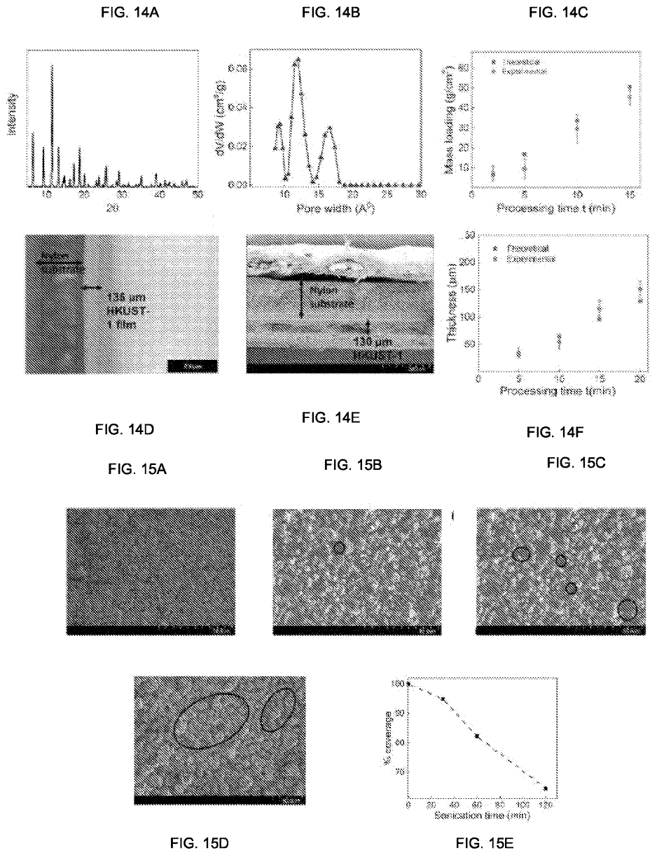

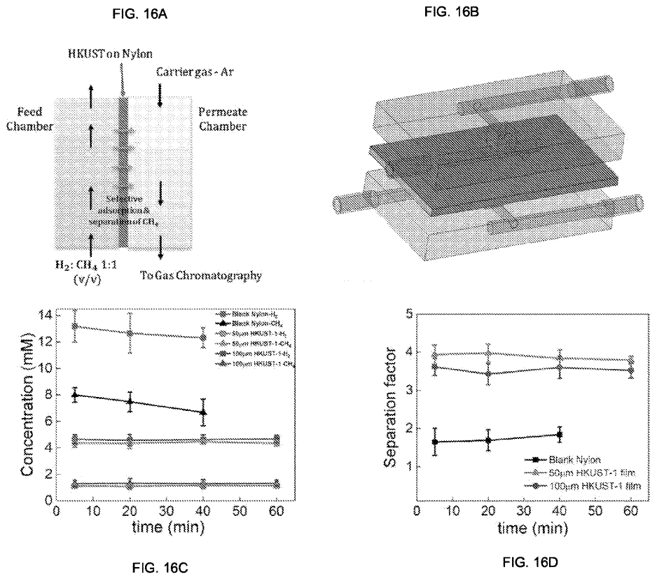

FIG. 10 shows the exploded view of the microfluidic device consisting of three parts—reaction chamber, supporting mesh (porous substrate holder), and vacuum chamber. A nylon membrane (porous substrate) is placed between the reaction chamber and the supporting mesh. The three parts and the nylon membrane were assembled utilizing threaded screws and bolts. FIG. 1 shows the snapshot of the complete experimental setup for film deposition. The dimensions of the 3D printed parts and their drawings are described in the additional description and shown in FIG. 3 and FIG. 4.

### MOF Film Synthesis Procedure

The construction and working procedure for film deposition were as follows. Syringes were first filled with 15 mL of each precursor solution (precursor metal and precursor organic linker) and wrapped with a silicon heating pad to attain the desired temperature (60-90° C.). The precursor solutions were then pumped through the microchannels at fixed flow rates (0.5-3 mL/min) to attain a desired concentration of reactants in the reaction chamber. The length and cross-section of the microchannel (path) were adjusted to obtain the necessary residence time to achieve a 5-10% MOF yield. The pre-nucleated HKUST-1 crystals (SBUs and combinations of SBUs) in the microchannel were then deposited in a square chamber where the reaction effluent (MOF precursor composition) came in contact with a first face of the nylon membrane (porous support). The continuous flow of the reaction mixture (MOF precursor composition) through the nylon membrane supported on the 3D printed mesh allowed the growth of the deposited nuclei/crystals (SBUs and combinations of SBUs) for the seamless formation of the film. After the desired period of deposition (2-20 minutes), the syringe pumps were switched off, and the vacuum pump was turned on to flush out the remaining reaction mixture (MOF precursor composition) in the microchannel and reaction chamber. After the suction of the reaction mixture, ethanol was pumped for about 30 minutes for thorough washing and removal of trapped solvent and precursor from the films. The microfluidic device was disassembled, and the film was further dried under a vacuum at room temperature for 24 hours. Alternatively, the film was immersed in ethanol for 24 hours in a glass bottle in batch for dissolution of trapped precursors, post which the film was dried under vacuum. The detailed experimental setup, CAD design, fabrication of the reactor-separator assembly, and operating described below and shown in FIG. 3 and FIG. 4.

A suitable MOF, HKUST-1, was deposited on nylon substrates at 90° C. by the coupled percolation-secondary growth mechanism. The residence and processing times were varied to obtain a range of mass loadings and thicknesses. High-resolution XRD and BET measurements (FIG. 4A and FIG. 4B) confirmed crystallinity and the pore size distributions of HKUST-1 deposition. The BET surface area of particles was obtained to be 1493 m²/g, which is equivalent to the previously reported values via the microwave approach for HKUST-1 film synthesis. The N₂ adsorption isotherm obtained is shown in FIG. 6. FIG. 14C shows the comparison of the theoretically predicted and experimentally obtained mass loading as a function of processing time. Film thicknesses were measured using optical microscopy, in which the portions of the films were mounted on vertical scanning electron microscopy (SEM) stubs for measurements. Thickness measurements of a few samples were performed under SEM and were in good agreement with that obtained from optical microscopy, as shown in FIG. 14D and FIG. 14E. FIG. 14F shows the comparison of the theoretically predicted and exemplary film thicknesses with an increase in time. The deviation of the quantitative aspects of the exemplary fabricated films (seen in FIGS. 4(c) and (f)) from the theoretical predictions can be attributed to the interfacial growth of crystals that occur due to the heterogeneous nucleation on the binding substrate.

Since a quantitative parameter to model for the heterogeneous nucleation cannot be included in the Multiphysics model, controlling the flowrates and passage of the reactant effluent (MOF precursor composition) through the porous substrate allowed its control to some extent during the process. Due to the lack of a significant pressure gradient across the porous membrane, the reaction effluent (MOF precursor composition) would easily pass through during the initial time stamps, leaving the crystals onto the substrate. However, with increasing yield, a fair amount of the reaction mixture (MOF precursor composition) accumulates inside the square chamber (approximately 30-40% by volume), and the remaining seeps through the membrane due to crystals blocking the flow path.

The quantity of deposited crystals can be controlled per unit time by controlling the residence time in these situations. Thus, operating at low residence times (high flowrates) results in maximum removal of the reaction effluent (MOF precursor composition), minimizing the heterogeneous growth on the substrate if desired. However, in the best interest of obtaining well-adhered and contiguous films, heterogeneous growth, to some extent, is desirable. Compared to films fabricated at low residence times, significant differences in the adherence to these substrates were observed. The physical stability of the film on the substrates was tested by the sonication method, which has been used before to demonstrate the stability of MOF films subjected to harsh conditions.

### Physical Adherence Test Using Sonication

The physical adherence of the HKUST-1 films on the nylon substrates were tested after complete drying of the fabricated films. The films were immersed in ethanol in a pyrex bottle and were placed in a Bransonic Ultrasonic bath or equivalent for various periods of time. The films were taken, dried and SEM analysis were performed on all the films.

A set of exemplary films were synthesized as described above to test the physical adhesion with a flowrate of 1 mL/min for 10 minutes, vacuum dried for 24 hours, and immersed in ethanol. Sonication was performed for 30, 60, and 120 minutes on separate films. Following this step, the films were vacuum dried for 24 h. The surface coverage and orientation of HKUST-1 crystals were studied by SEM and further analyzed in Image J to obtain the coverage values to demonstrate the strong physical adhesion obtained using the PAC technique.

FIG. 15A-15D show the SEM images of the deposited crystals. It was seen that after 30 minutes, more than 95% of the deposited crystals remained intact on the surface without any change in the thickness of the film (observed under an optical microscope). Voids started to appear in the deposition after 60 minutes with ˜80% of the crystals intact, which further reduced to 60% intact crystal after 120 minutes. The percentage coverage vs. sonication time is shown in FIG. 15E. Films of similar thickness and loading were fabricated at higher flowrates, i.e., 2.5-3 mL/min and subjected to sonication for the physical adherence test. In accordance with the principles herein, % coverage slightly dropped compared to the films that were fabricated at 1 mL/min. Thus, the reaction effluent (MOF precursor composition) in the square chamber promotes inter-grain growth on the substrate, enhancing the packing and conformity of the deposited films with uniform coverage.

Along with the strong adherence to the substrate, minimizing the inter-grain boundaries or, in other words, cracking is essential in the exemplary process. This phenomenon is more prominent in deposition on porous substrates than on solid substrates. It was worth noting that when the films were dried at high temperatures in a conventional oven, significant cracks between the films were observed compared to the vacuum-dried films. Therefore, this post-processing step is equally crucial to preserve the synthesized films' physical stability. Ultimately, the exemplary films displayed strong adherence and intact coverage post sonication, proving that the films can withstand high-pressure environments.

### Characterization of HKUST Films

The crystallinity of the exemplary thin films was confirmed using high-resolution XRD technique. The pore size distribution and BET surface areas of the deposited material were determined using N₂ adsorption isotherms. The deposition and thickness of the films were analyzed using SEM and optical microscopy techniques. Specific instrumentation and characterization procedures for each of the mentioned techniques is described below.

### Preparation and Use of MOF-505 Films

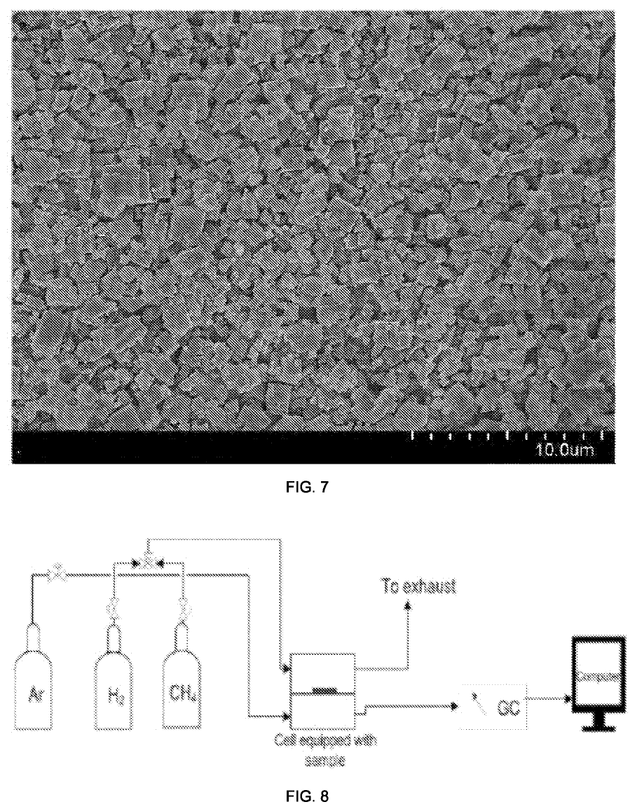

MOF-505 films were also fabricated using the method described above. A previously reported batch synthesis for MOF-505 was adopted to fabricate these films continuously. An SEM of the fabricated film is shown in FIG. 7. Based on the rate kinetics of a given MOF/COF, film formation with effective deposition can easily be achieved with this method by varying temperature and residence time variables. The control of the operating parameters to obtain desired thickness and loading makes the PAC process a potential candidate for scaling up the film fabrication processes.

CH₄/H₂ Gas Separation Experiments

Two identical cells with inlet and outlet channels were 3D printed in-house. The fabricated exemplary HKUST-1 films or MOF-505 films on nylon prepared as described above were sandwiched between the two cells. The side exposed to HKUST-1 film or MOF-505 film was the feed chamber and the other side exposed to bare nylon was the permeate chamber. This setup was fastened with screws and bolts to ensure no gas leaks, the edges were sealed with the help of the 3D printing resin and the setup was cured under UV light for 30 minutes. CH₄ and H₂, 50% by volume each, were sent to the feed chamber at fixed flowrates and the carrier gas, Argon (Ar) was sent to the permeate chamber in a cross-current fashion. The separated gas mixture on the permeate side was fed to a gas chromatography (GC) system, where the concentration of each gas was measured. These experiments were performed for 1 hour continuously and the data was recorded every 10 minutes. Control experiments with bare nylon were conducted to demonstrate the effect of HKUST-1 film on the separation factor of the gas mixture.

The separation experiments were designed such that the gas mixture enters the upstream at a flowrate of 200 standard cm³/min (SCCM), each at 50% by volume (100 SCCM H₂+100 SCCM CH₄). Downstream of the separation process, the gas was mixed with Argon (Ar) (the carrier gas) which was then sent to a gas chromatography system to determine the concentration of separated species. FIG. 16A shows the schematic of these experiments. The carrier gas Ar is flown in a counter-current fashion. The device housing the membrane for these experiments was fabricated in-house (FIG. 16B). As shown in this figure, the setup is assembled as shown in FIG. 8. FIG. 16C shows the concentration of H₂ and CH₄ gas with a blank nylon membrane, with 50 μm and 100 μm HKUST-1 deposition on nylon. The concentration of each of the gases on the upstream/feed side was 20 mM (considering 100 SCCM flowrate of each gas). With no deposition, about 70% of the H₂ and less than 50% of CH₄ were detected on the permeate side. However, with exemplary HKUST-1 deposited films, the concentration of CH₄ on the permeate side drops significantly. Thus, HKUST-1 successfully traps the majority of CH₄. The concentration of H₂ also dropped; however, the separation gap between the two gases was increased, thus showing a high selectivity of HKUST-1 towards CH₄. The permeability values of H₂ and CH₄ were 4.85×10⁻⁶ mol·m⁻²·s⁻¹·Pa⁻¹ and 1.25×10⁻⁶ mol·m⁻²·s⁻¹·Pa⁻¹, respectively which are in agreement with the previously reported separation experiments for this mixture. Based on the obtained permeabilities, the separation factors were calculated using the following equation:

$$Separation factor = \frac{Permeability of {H}_{2} ( mol \cdot {m}^{- 2} {s}^{- 1} {Pa}^{- 1} )}{Permeability of {CH}_{4} ( mol \cdot {m}^{- 2} {s}^{- 1} {Pa}^{- 1} )}$$

FIG. 16D shows the steady separation factor of 4.3 with a 50 and 100 μm thick HKUST-1 deposition. Negligible changes in the separation factors were observed as a function of film thickness. This suggests that the selectivity of CH₄ on HKUST-1 has a very slight dependence on the film thickness. The obtained values are not only in agreement with the previous experimental efforts, but also with theoretical values of the separation factor for H₂/CH₄ mixture. The Knudsen separation factor which is the ratio of the diffusion fluxes of both the gases, states that the diffusion fluxes are inversely proportional to the square root molar masses of the gas. Based on that, we obtain 2.82 as the separation factor for this mixture. The gas separation experiments were also performed on films that did not have complete coverage and the separation factors were observed to drop. Thus, a uniform and contiguous deposition ensures the effective separation of this gas mixture. This would also be important for other gas mixtures that can be effectively separated using suitable MOF films, such as HKUST-1 films.

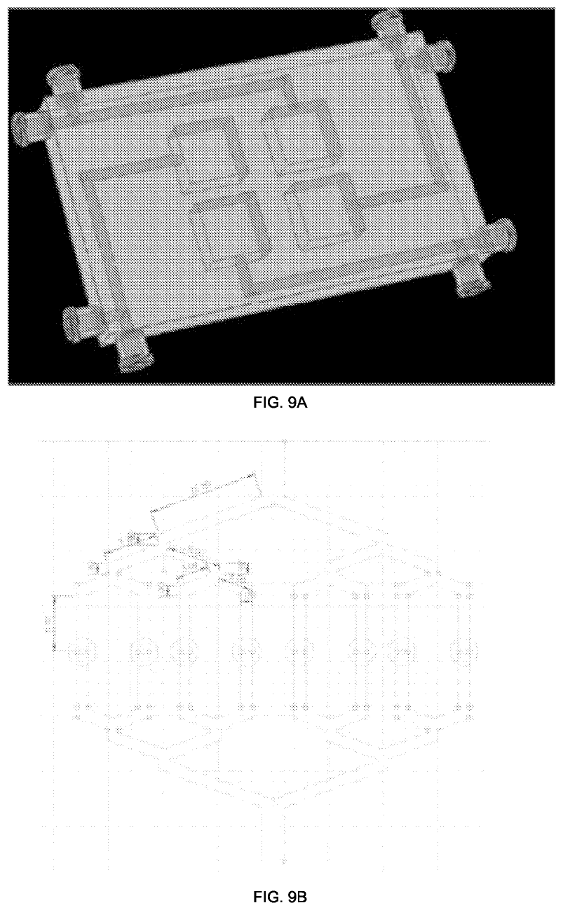

To accelerate the fabrication and screening of these exemplary films, a reaction chamber consisting of four deposition chambers was formed, as shown in FIG. 9, that can be used to fabricate multiple films in a single run. The design shows the tubular channel of equal length (16.5 cm) for each deposition chamber. This length can also be varied while keeping a constant flowrate across all the chambers to vary the loading and thickness of the films. Flow distributors can be utilized instead of multiple pumps, if desired, to vary the residence times of the precursors entering the different chambers. This would yield films of different thicknesses and loadings as desired with very short processing times.

The results achieved herein provided an inexpensive, reliable, and scalable PAC fabrication process for forming robust MOF (HKUST-1 and other) films with the development and use of a well-controlled continuous microfluidic device that helps fine-tune the quantitative and qualitative aspects of the films.

The methods of the disclosure, i.e., percolation coupled with controlled heterogeneous nucleation and growth, ensures film contiguity and strong adherence to the substrate. The fabricated HKUST-1 exemplary films perform well in separating the CH₄/H₂ binary mixture with reproducible and steady separation factors. These films can be easily adapted to other applications like electrocatalysis by enhancing their conductivity by soaking them in suitable conductive solutions like Nafion, TCNQ, etc., for example. The process herein can be adapted to various porous substrates like PVDF, PTFE, carbon paper, etc., while offering flexibility to make substrate modifications before assembling the devices, making it applicable for a wide range of multifaceted depositions.

In summary, kinetic data obtained from the batch was utilized to develop a COMSOL Multiphysics device model, which provided necessary insight into the design and operational parameters for exemplary processes. This straightforward design and process of fabrication can be easily deployed in fabricating a wide range of MOF and COF films with effective kinetic formation rates.

### Additional Description

### HKUST-1 Batch In-Situ Experimental Setup

In-situ FTIR studies were performed ion a Bruker Invenio-S spectrometer (or equivalent) using Attenuated Total Reflectance (ATR) mode coupled with a Pike Veemax-III ATR module. A module compatible high temperature plate fixed with a Zinc Selenide (ZnSe) crystal was placed on the VeeMax accessory and the temperature of the plate was set to the desired temperature. An in-house 3D printed batch cell was centered over the ZnSe crystal. Cu(NO₃)₂·3H₂O was first inserted in the jackfish cell to subtract the background. Trimesic acid was then added, and the spectra was recorded in real time. The final starting concentrations of Cu(NO₃)₂·3H₂O and trimesic acid were 0.4 M and 0.22 M, respectively. The total volume of the reactant mixture was set to 1 mL for all the experiments. Negative absorbance peaks represent the consumption of Trimesic acid as the reaction proceeds forward. The spectrum at each time stamp was recorded with a spectral resolution of 2 cm⁻¹ at a sampling rate of 7.5 kHz, averaged over 8 scans. The beam aperture was set to 6 mm, and the specular angle was set to 600. FIG. 3 shows the experimental setup for in-situ FTIR studies. Calibration of known HKUST-1 concentrations (synthesized separately in batch) in DMF was performed to appropriately quantify the obtained yield in the experiments.

ZnSe Limitations: The ZnSe crystal provides a wider range of the spectrum all the way up to 550 cm 1. Since a clear and reproducible increase in intensities was achieved at 729 cm⁻¹ (Cu—O bond signature peak of HKUST-1), the choice of crystal was ZnSe. However, the crystal has a pH limitation of between 5 to 8. It was seen from stand-alone batch experiments that the acidity of the reactant mixture increases significantly at high temperatures (above 60° C.) due to the presence of Trimesic acid leading to low pH. This would lead to significant cloudiness of the ZnSe crystal, which would, in turn, affect the results and reproducibility of those results. To avoid this scenario, the process was conducted in the range 35 to 60° C. at 5° C. intervals, and the rate constants were predicted for higher temperatures using COMSOL simulations. FIG. 5 shows the change in color of a pH strip when dipped in HKUST-1 reactant mixture at 90° C. A small test piece of ZnSe crystal was dipped inside the same reactant mixture and the effect on it after 5 minutes is reported in FIG. 5.

### Reactor-Separator Assembly Experimental Setup and Fabrication

Experimental setup for the thin film synthesis is shown in FIG. 1. The 3D CAD design of the parts of the assembly was conducted in Solidworks. A Form-3 printer (Formlabs Inc. USA) was used to 3D print the parts of the assembly. Post printing, the parts were thoroughly washed with Isopropyl Alcohol (IPA) for 30 minutes. Post washing the channels of the reactor assembly were washed with IPA by means of a syringe. The channels and the parts were further air dried and cured under UV light for 30 minutes.

As shown in FIG. 1, the individual parts of the assembly were fixed together by means of suitable attachment devices, such as, for example, screws and bolts used herein. The nylon substrate was sandwiched between the top reaction chamber and the supporting mesh.

Individual precursor solutions (precursor metal ion and precursor organic linker) were loaded on separate glass syringes, which were further wrapped with silicone heating tape to attain high temperatures of the reactants. The syringes were loaded onto the syringe pump and the flowrates were set as per desired residence times. The pre-nucleated HKUST-1 crystals (SBUs and combinations of SBUs) form in the tubular channel (path) and get loaded onto the first face of the nylon substrate. About 50% of the reaction mixture (MOF precursor solution) seeps through the substrate and gets separated, while the remaining 50% effluent is either trapped in the porous substrate/between the crystals or floats in the deposition chamber. Once the deposition process is completed, the reaction mixture (MOF precursor solution) is completely removed, such as via a vacuum pump for example. Next, the vacuum pump is turned off and ethanol is loaded on separate syringes and pumped through the setup for 10 minutes. The vacuum pump is turned on to remove all the ethanol, and this 10 min cycle of ethanol washing is repeated for a total of 3 times for complete removal of the precursors. After the third washing cycle, the vacuum pump is turned on and allowed to run for 1 hour and the film is allowed to partially dry in the assembly. This is done in order to ensure that the nylon has dried and is not stuck to the top chamber/supporting mesh leading to the tearing of the sample due to wetness. Post this, the assembly is separated, in the exemplary case unscrewed, and the deposited film on nylon is recovered and is allowed to dry under vacuum at room temperature for complete removal of ethanol. These films are further characterized for thickness (SEM and optical microscopy), mass loading, high-resolution XRD and BET analysis.

### X-Ray Diffraction Measurements

High-resolution X-Ray diffraction measurements were performed on a Bruker-Nano Discover 8 X-Ray Diffraction system. The system uses Cu as the target material, with CuKα radiation λ=1.54A0. The generator was set to 40 kV and 40 mA. The resolution for measurements was set to 2θ=0.020.

### BET Surface Area and Pore Size Distribution Measurements

N₂ adsorption isotherms were carried out by means of a Micrometrics Tristar II 3020 at 77K. The BET surface area was determined in the P/PO range of 0.0 to 1.0. FIG. 6 shows the adsorption, and the desorption isotherm plots.

### Optical Microscope Thickness Measurements

The thickness measurements on the optical microscope were performed on an Olympus BX53M. Portions of the film were mounted on an SEM vertical mount with help of a carbon double-sided tape. The lamp installed at the top of the microscope was utilized to conduct these measurements. The thicknesses of samples were verified using SEM as shown in FIG. 14.

### SEM Measurements

The lateral film morphologies and vertical thickness measurements using scanning electron microscopy were performed on a Hitachi SU-8030. The measurements were performed at 5 kV accelerating voltage.

### COMSOL Simulations

Chemistry: Three separate species were setup with one reaction A+B→C. The molecular weights and the densities of the reactants and product were included. These values were averaged with the solvent molar mass and density as the starting mixture is homogenous. Lastly, to account for the rate constants, the reaction was assumed to be second order and the value for activation energy was acquired from the FTIR batch experiments. This module utilized the conventional Arrhenius equation to compute the rate constants at the respective inlet temperature that was specified under the ‘Heat transfer in fluids’ module.

Laminar Flow: Navier Stokes equation is implemented by COMSOL to generate a velocity profile based on the inlet flowrates. Intensive properties like viscosity and initial pressure were set and the boundary condition was set to ‘No slip’. For every simulation, the velocity in m/s was varied as per the flowrate and the final profiles were obtained.

Transport of diluted species: In the continuity equation utilized by COMSOL under this module, the inlet concentration conditions were set 0.4M and 0.22M for Copper Nitrate and Trimesic acid concentrations respectively.

Heat Transfer in fluids: Energy balance equation with appropriate conduction and convection terms were utilized to evaluate the temperature profiles. The inlet boundary condition was set to T=363K. The insulation parameters were input as per that of polymethyl methacrylate (PMMA) as it is the major component of the resin that is used to fabricate the reactor. The following physics were coupled using the ‘Multiphysics’ option in COMSOL to obtain the profiles mentioned above: (a) Non-isothermal flow (Laminar flow and Heat transfer in fluids), (b) Reacting flow (Laminar flow and Transport of diluted species). The ‘Chemistry’ was automatically linked to the ‘Transport of diluted species’ by appropriately adding the species at their respective inlets.

### CH4-H2 Gas Separation Experiments

Ar (99.99%), CH₄ (99.999%), H₂ (99.99%) gases were obtained from Praxair USA. The schematic of the experimental setup is shown in FIG. 8. Dry samples deposited over nylon membrane were tested at room temperature (˜25° C.). Gas mixtures were fed at 50% and the total flow rate was maintained constantly on the feed side, facing toward the sample. Under isothermal conditions, the permeate gases were quantified using an SRI 8610C GC MG #5. The gas chromatography (GC) setup consists of a thermal conductivity detector (TCD) and flame ionization detector (FID). H₂ at 30 psi and internally compressed air at 7 psi was employed to ignite the flame required by FID. The hydrocarbon (CH₄) gas was detected using FID, and non-hydrocarbon (H₂) gas was detected using TCD. Prior to each run, the experimental setup was purged with pure Argon on permeate side until a blank signal on GC was obtained. During the quantification by GC, Ar was used as carrier gas on permeate side.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

The foregoing description is given for clearness of understanding only, and no unnecessary limitations should be understood therefrom, as modifications within the scope of the invention may be apparent to those having ordinary skill in the art.

1. A method of coating a porous substrate with a metal-organic framework (MOF), comprising:
flowing a MOF precursor composition comprising MOF secondary building units (SBUs) and combinations of SBUs suspended in a solvent through a porous substrate having a first face and a second face, thereby depositing MOF SBUs and combinations of SBUs on the first face of the porous substrate,
wherein each of the MOF SBUs comprise a metal ion coordinated to an organic linker, and
wherein during flowing the MOF precursor composition through the porous substrate, MOF SBUs and combinations of SBUs self-assemble into MOF crystals to provide a porous substrate coated with a thin film of MOF crystals on the first face of the porous substrate.

2. The method of claim 1, further comprising admixing a composition comprising MOF precursor metals and a composition comprising MOF precursor organic linkers to form the MOF precursor composition comprising the SBUs and the combinations of SBUs.

3. The method of claim 1, further comprising stopping the flow of the MOF precursor composition.

4. The method of claim 3, wherein after stopping the flowing, the method further comprises applying a vacuum to the second face of the porous substrate, thereby patching the thin film to form a contiguous network of the MOF crystals to yield a leak-proof coating.

5. The method of claim 4, further comprising stopping the vacuum.

6. The method of claim 1, further comprising washing the porous substrate coated with the thin film of MOF crystals to dissolve any unreacted MOF precursor metals and/or MOF precursor organic linkers.

7. The method of claim 1, wherein the solvent is selected from the group of an alcohol, a non-aqueous solvent, water, and a combination thereof.

8.-10. (canceled)

11. The method of claim 1, wherein the flowing of the MOF precursor composition comprising the SBUs is performed for a time and at a rate sufficient to provide a predetermined thickness of the thin film of MOF.

12. The method of claim 1, wherein the path length is sufficient to prevent the MOF SBUs from forming large crystals prior to depositing on the porous substrate.

13. The method of claim 1, wherein a flow distribution of the MOF precursor composition is uniform.

14. The method of claim 1, wherein during the flowing of the MOF precursor composition, the MOF precursor composition has a temperature in a range of about 50° C. to about 110° C., about 60° C. to about 100° C., about 70° C. to about 90° C., or about 80° C.

15. The method of claim 1, wherein during the flowing the MOF precursor composition has a variation in temperature between 0° C. and 5° C.

16. The method of claim 1, wherein during the flowing the MOF precursor composition has a temperature corresponding to a temperature sufficient to promote bulk synthesis of the MOF crystals.

17. The method of claim 1, wherein the MOF SBUs comprise a MOF precursor metal coordinated to a MOF precursor organic linker.

18. The method of claim 17, wherein the MOF precursor metal comprises metal-oxo clusters of Zr, Ti, Hf, metal salts including Cu, Al, Ni, Fe, or a combination of metal-oxo clusters, a combination of metal salts, or a combination of a metal-oxo cluster and a metal salt.

19. The method of claim 17, wherein the MOF precursor organic linker comprises benzene dicarboxylic acid, trimesic acid, 3,3′,5,5′-biphenyltetracarboxylic acid, 1,3,6,8-tetrakis(p-benzoic acid) pyrene, and a combination thereof.

20. The method of claim 1, wherein the porous substrate comprises a nylon sheet.

21. A separation membrane for separating a binary gas mixture comprising: a well-patched, contiguous MOF coated porous substrate.

22.-25. (canceled)

26. A method of separating a binary gas mixture comprising flowing a binary gas mixture through the separation membrane of claim 21.

27. (canceled)

28. A material substrate, device, or system comprising the separation membrane of claim 21 to facilitate the separation of binary gas mixtures.
